(19) United States
(12) Patent Application Publication
(10) Pub. No.: US 2020/0382212 A1
(43) Pub. Date: Dec. 3, 2020

(54) DEVICES AND METHODS FOR THE TRANSMISSION AND RECEPTION OF CODED LIGHT

(71) Applicant: SIGNIFY HOLDING B.V., EINDHOVEN (NL)

(72) Inventors: DIRK VALENTINUS RENÉ ENGELEN, HEUSDEN-ZOLDER (BE); BARTEL MARINUS VAN DE SLUIS, EINDHOVEN (NL); DZMITRY VIKTOROVICH ALIAKSEYEU, EINDHOVEN (NL); MUSTAFA TOLGA EREN, EINDHOVEN (NL)

(21) Appl. No.: 16/970,448

(22) PCT Filed: Feb. 11, 2019
(86) PCT No.: PCT/EP2019/053283

§ 371 Date: Aug. 17, 2020

(30) Foreign Application Priority Data
Feb. 16, 2018 (EP) 18157059.9

(51) Int. Cl. H04B 10/116; H05B 47/195

(52) U.S. Cl. CPC H04B 10/116; H05B 47/195

(57) ABSTRACT

A method comprising: receiving multiple frames, each frame capturing parts of a coded light message in different areas in each frame over time, the message comprising a sequence of data symbols; decoding the parts of the message; placing the decoded parts into a respective message buffer, each message buffer being associated with one of the respective areas within each frame; determining, based on the data symbols placed in the message 5 buffers, one or more phase shifts in the data symbols between each of one or more pairs of said decoded parts; and reconstructing the message, said reconstructing comprising aligning the decoded parts in the message buffers based on the determined phase shifts, and merging the aligned message parts into a single buffer.

### TECHNICAL FIELD

The present disclosure relates to the communication of coded light signals embedded in the light emitted by a lighting device.

### BACKGROUND

Coded light communication refers to techniques whereby information is communicated in the form of a signal embedded in the visible light emitted by a light source. Coded light is sometimes also referred to as visible light communication (VLC).

The signal is embedded by modulating a property of the visible light, typically the intensity, according to any of a variety of suitable modulation techniques. In some of the simplest cases, the signalling is implemented by modulating the intensity of the visible light from each of multiple light sources with a single periodic carrier waveform or even a single tone (sinusoid) at a constant, predetermined modulation frequency. If the light emitted by each of the multiple light sources is modulated with a different respective modulation frequency that is unique amongst those light sources, then the modulation frequency can serve as an identifier (ID) of the respective light source or its light.

An example of such a system may for example be found in US granted patent U.S. Pat. No. 9,742,493 B2 which discloses a method and system for emitting an LCOM message by means of a luminaire and receiving and reconstructing such a message using a light receiver, which may take the form of a digital camera of a mobile receiver such as a mobile phone or tablet.

In more complex schemes a sequence of data symbols may be modulated into the light emitted by a given light source. The symbols are represented by modulating any suitable property of the light, e.g. amplitude, modulation frequency, or phase of the modulation. For instance, data may be modulated into the light by means of amplitude keying, e.g. using high and low levels to represent bits or using a more complex modulation scheme to represent different symbols. Another example is frequency keying, whereby a given light source is operable to emit on two (or more) different modulation frequencies and to transmit data bits (or more generally symbols) by switching between the different modulation frequencies. As another possibility a phase of the carrier waveform may be modulated in order to encode the data, i.e. phase shift keying.

In general the modulated property could be a property of a carrier waveform modulated into the light, such as its amplitude, frequency or phase; or alternatively a baseband modulation may be used. In the latter case there is no carrier waveform, but rather symbols are modulated into the light as patterns of variations in the brightness of the emitted light. This may for example comprise modulating the intensity to represent different symbols, or modulating the mark:space ratio of a pulse width modulation (PWM) dimming waveform, or modulating a pulse position (so-called pulse position modulation, PPM). The modulation may involve a coding scheme to map data bits (sometimes referred to as user bits) onto such data symbols. An example is a conventional Manchester code, which is a binary code whereby a user bit of value 0 is mapped onto a data symbol in the form of a low-high pulse and a user bit of value 1 is mapped onto a data symbol in the form of a high-low pulse. Another example coding scheme is the so-called Ternary Manchester code developed by the applicant.

Based on the modulations, the information in the coded light can be detected using any suitable light sensor. This can be either a dedicated photocell (point detector), or a camera comprising an array of photocells (pixels) and a lens for forming an image on the array. E.g. the camera may be a general purpose camera of a mobile user device such as a smartphone or tablet. Camera based detection of coded light is possible with either a global-shutter camera or a rolling-shutter camera. E.g. rolling-shutter readout is typical to mobile CMOS image sensors found in everyday mobile user devices such as smartphones and tablets). In a global-shutter camera the entire pixel array (entire frame) is captured at the same time, and hence a global shutter camera captures only one temporal sample of the light from a given luminaire per frame. In a rolling-shutter camera on the other hand, the frame is divided into lines in the form of horizontal rows and the frame is exposed line-by-line in a temporal sequence, each line in the sequence being exposed at a slightly later time than the last. Each line therefore captures a sample of the signal at a different moment in time. Hence while rolling-shutter cameras are generally the cheaper variety and considered inferior for purposes such as photography, for the purpose of detecting coded light they have the advantage of capturing more temporal samples per frame, and therefore a higher sample rate for a given frame rate. Nonetheless coded light detection can be achieved using either a global-shutter or rolling-shutter camera as long as the sample rate is high enough compared to the modulation frequency or data rate (i.e. high enough to detect the modulations that encode the information).

Coded light is often used to embed a signal in the light emitted by an illumination source such as an everyday luminaire, e.g. room lighting or outdoor lighting, thus allowing the illumination from the luminaires to double as a carrier of information. The light thus comprises both a visible illumination contribution for illuminating a target environment such as room (typically the primary purpose of the light), and an embedded signal for providing information into the environment (typically considered a secondary function of the light). In such cases, the modulation is typically performed at a high enough frequency so as to be beyond human perception, or at least such that any visible temporal light artefacts (e.g. flicker and/or strobe artefacts) are weak enough not to be noticeable or at least to be tolerable to humans. Thus the embedded signal does not affect the primary illumination function, i.e. so the user only perceives the overall illumination and not the effect of the data being modulated into that illumination. E.g. Manchester coding is an example of a DC free code, wherein the power spectral density goes to zero at zero Hertz, with very little spectral content at low frequencies, thus reducing visible flicker to a practically invisible level. Ternary Manchester is DC² free, meaning not only does the power spectral density go to zero at zero Hertz, but the gradient of the power spectral density also goes to zero, thus eliminating visible flicker even further.

Coded light can be used in a variety of possible applications. For instance a different respective ID can be embedded into the illumination emitted by each of the luminaires in a given environment, e.g. those in a given building, such that each ID is unique at least within the environment in question. E.g. the unique ID may take the form of a unique modulation frequency or unique sequence of symbols. This in itself can then enable any one or more of a number of applications. For instance, one application is to provide information from a luminaire to a remote control unit for control purposes, e.g. to provide an ID distinguishing it amongst other such luminaires which the remote unit can control, or to provide status information on the luminaire (e.g. to report errors, warnings, temperature, operating time, etc.). For example the remote control unit may take the form of a mobile user terminal such as a smartphone, tablet, smartwatch or smart-glasses equipped with a light sensor such as a built-in camera. The user can then direct the sensor toward a particular luminaire or subgroup of luminaires so that the mobile device can detect the respective ID(s) from the emitted illumination captured by the sensor, and then use the detected ID(s) to identify the corresponding one or more luminaires in order to control it/them (e.g. via an RF back channel). This provides a user-friendly way for the user to identify which luminaire or luminaires he or she wishes to control. The detection and control may be implemented by a lighting control application or “app” running on the user terminal.

In another application the coded light may be used in commissioning. In this case, the respective IDs embedded in the light from the different luminaires can be used in a commissioning phase to identify the individual illumination contribution from each luminaire.

In another example, the identification can be used for navigation or other location-based functionality, by mapping the identifier to a known location of a luminaire or information associated with the location. In this case, there is provided a location database which maps the coded light ID of each luminaire to its respective location (e.g. coordinates on a map or floorplan), and this database may be made available to mobile devices from a server via one or more networks such as a wireless local area network (WLAN) or mobile cellular network, or may even be stored locally on the mobile device. Then if the mobile device captures an image or images containing the light from one or more of the luminaires, it can detect their IDs and use these to look up their locations in the location database in order to estimate the location of the mobile device based thereon. E.g. this may be achieved by measuring a property of the received light such as received signal strength, time of flight and/or angle of arrival, and then applying technique such as triangulation, trilateration, multilateration or fingerprinting; or simply by assuming that the location of the nearest or only captured luminaire is approximately that of the mobile device. In some cases such information may be combined with information from other sources, e.g. on-board accelerometers, magnetometers or the like, in order to provide a more robust result.

The detected location may then be output to the user through the mobile device for the purpose of navigation, e.g. showing the position of the user on a floorplan of the building. Alternatively or additionally, the determined location may be used as a condition for the user to access a location based service. E.g. the ability of the user to use his or her mobile device to control the lighting (or another utility such as heating) in a certain region or zone (e.g. a certain room) may be made conditional on the location of his or her mobile device being detected to be within that same region (e.g. the same room), or perhaps within a certain control zone associated with the lighting in question. Other forms of location-based service may include, e.g., the ability to make or accept location-dependent payments.

As another example application, a database may map luminaire IDs to location specific information such as information on a particular museum exhibit in the same room as a respective one or more luminaires, or an advertisement to be provided to mobile devices at a certain location illuminated by a respective one or more luminaires. The mobile device can then detect the ID from the illumination and use this to look up the location specific information in the database, e.g. in order to display this to the user of the mobile device. In further examples, data content other than IDs can be encoded directly into the illumination so that it can be communicated to the receiving device without requiring the receiving device to perform a look-up.

Thus coded light has various commercial applications in the home, office or elsewhere, such as a personalized lighting control, indoor navigation, and location based services, etc.

As mentioned above, coded light can be detected using an everyday “rolling shutter” type camera, as is often integrated into an everyday mobile user device like a mobile phone or tablet. In a rolling-shutter camera, the camera's image capture element is divided into a plurality of horizontal lines (i.e. rows) which are exposed in sequence line-by-line. That is, to capture a given frame, first one line is exposed to the light in the target environment, then the next line in the sequence is exposed at a slightly later time, and so forth. Each line therefore captures a sample of the signal at a different moment in time (typically with the pixels from each given line being condensed into a single sample value per line). Typically the sequence “rolls” in order across the frame, e.g. in rows top to bottom, hence the name “rolling shutter”. When used to capture coded light, this means different lines within a frame capture the light at different moments in time and therefore, if the line rate is high enough relative to the modulation frequency, at different phases of the modulation waveform. Thus the rolling-shutter readout causes fast temporal light modulations to translate into spatial patterns in the line-readout direction of the sensor, from which the encoded signal can be decoded.

Because a rolling-shutter camera captures each frame line-by-line in a sequence, this means that when a rolling-shutter camera is used to capture a coded light signal comprising a cyclically repeated message, each line captures a respective sample of the message and each frame captures a respective fragment of the message, each fragment made up of a respective subsequence of the samples. For most combinations of frame rate and message repetition period, the frame rate and message duration have no particular relationship between one another. This is desirable since it means that each frame sees a different fragment of the message, and the signal can then be reconstructed from the different fragments. Techniques for this so-called “stitching” together of message fragment are known to the skilled person from international patent application publication number WO2015/121155.

### SUMMARY

When a camera captures images of a light source transmitting a coded light message, only a small part of the coded light message is captured in each image frame. For instance in the case of a rolling-shutter camera, the footprint of the light source within a frame may only cover a small proportion of the lines in the frame. Therefore a larger number of frames is required to reconstruct the whole message. This increases the time taken to reconstruct the message at the receiver. If multiple light sources are transmitting the same coded light message, the same parts of the coded light message are merely captured in each frame. This may increase the chances of receiving an error-free message part, but does nothing to improve the speed of data transfer.

According to a first aspect disclosed herein, there is provided a receiving apparatus for receiving a coded light message from a plurality of spatially separated transmitters that transmit one and the same message, wherein the different transmitters are configured to transmit phase shifted versions of the coded light message relative to one another, the receiving apparatus comprising: an interface configured to receive, from a camera, one or more frames, each frame capturing a plurality of respective parts of a coded light message in a plurality of spatially separated respective areas in each frame, wherein each respective part originates from a different respective transmitter and is captured in a different spatially separated respective area, and wherein the coded light message comprises a sequence of data symbols; a plurality of message buffers; and a decoder configured to: decode the respective parts of the coded light message captured in each frame; place each of the decoded parts into a respective message buffer, wherein each respective message buffer is associated with one of the plurality of respective areas within each frame; determine, based on the data symbols in the message buffers, one or more phase shifts in the data symbols between each of one or more pairs of said two or more decoded parts; and reconstruct the coded light message, wherein said reconstructing comprises aligning the decoded parts in the message buffers based on the determined one or more phase shifts, and merging the aligned message parts into a single message buffer.

The present invention therefore solves the problem of previous systems by using multiple transmitters to transmit one and the same message, but wherein different transmitters transmit phase shifted versions of the message content relative to one another. A receiver seeing more than one of the transmitters is therefore able to receive more message content from the transmitters in a shorter amount of time. Not only is it possible to receive single messages in a shorter amount of time, but the speed of data transfer through a lighting system as whole is also increased.

In an example, the decoder is configured to search for correlations between the data symbols of the decoded parts placed in different ones of the message buffers, wherein said searching comprises determining correlations between the data symbols of two or more of the decoded parts.

In an example, said determining of the one or more phase shifts is based on the determined correlations in the data symbols in the message buffers.

The correlations could be between parts from the same frame and/or different frames.

In an example, the decoder is configured to identify a stop and/or start sequence within the decoded parts in the respective message buffers, wherein said aligning is based on the identified stop and/or start sequence.

In an example, the decoder is configured to: perform said decoding, placing and determining for a first set of the received frames; wherein said determining of the one or more phase shifts comprises estimating, based on any determined correlations between the data symbols of two or more of the decoded parts decoded from the first set of the received frames, the one of more phase shifts; verify the estimated one or more phase shifts by determining whether the data symbols in corresponding positions in the respective message buffers are the same; and if the data symbols in corresponding positions in the respective message buffers are determined to be the same, reconstruct the coded light message based on the verified one or more phase shifts; or if the data symbols in corresponding positions in the respective message buffers are determined not to be the same, repeat said performing, estimating and verifying for one or more subsequent sets of the received frames until the estimated one or more phase shifts are verified.

In an example, the decoder is configured to: receive a further one or more frames comprising coded light signals in the plurality of respective areas within each frame, each frame capturing a part of a second coded light message within the coded light signals in the plurality of respective areas; decode the respective parts of the second coded light message captured in each frame; and reconstruct the second coded light message by placing the decoded parts in the single message buffer, wherein the decoded parts are aligned in the single message buffer based on the previously determined one or more phase shifts.

In an example, the data symbols are in corresponding positions if they are positioned within a threshold of one another in the message buffer.

In an example, the receiving apparatus is configured to receive information comprising the one or more phase shifts; and wherein the decoder is configured to reconstruct the coded light message by aligning the decoded parts in the message buffers based on the one or more phase shifts in the received information.

In an example, the decoder is configured to: generate a request to modify at least one of the one or more phase shifts; and wherein the receiving apparatus is configured to transmit the generated request to one or more transmitters responsible for transmitting the coded light signals in the received plurality of frames.

In an example, the receiver is configured to communicate with the one or more transmitters over a wireless communication channel.

In an example, the decoder is configured to: determine which of the one or more transmitters responsible for transmitting the coded light signals are present in the received frames; wherein the request to modify at least one of the one or more phase shifts is based on which of the one or more transmitters are present in the received frames.

In an example, the receiver comprises at least one of: (i) a rolling-shutter camera, and (ii) a global-shutter camera, each configured to capture the one or more frames. When a rolling-shutter camera is used, each frame is captured as a temporal sequence of lines, and each line thus samples the message at a different moment in time. In such cases, a footprint of each light source (transmitter) will cover a respective subset of the lines within the frame. Hence each of said parts of the message is captured by a respective subset of the rolling-shutter lines.

According to a second aspect disclosed herein, there is provided a method of reconstructing a coded light message from a plurality of spatially separated transmitters that transmit one and the same message, wherein the different transmitters are configured to transmit phase shifted versions of the coded light message relative to one another transmitted in coded light signals, the method comprising: receiving one or more frames, each frame capturing respective parts of a coded light message in a plurality of spatially separated respective areas in each frame, wherein each respective part originates from a different respective transmitter and is captured in a different spatially separated respective area over time, wherein the coded light message comprises a sequence of data symbols; decoding the respective parts of the coded light message captured in each frame; placing each of the decoded parts into a respective message buffer, wherein each respective message buffer is associated with one of the plurality of respective areas within each frame; determining, based on the data symbols in the message buffers, one or more phase shifts in the data symbols between each of one or more pairs of said two or more decoded parts; and reconstructing the coded light message, wherein said reconstructing comprises aligning the decoded parts in the message buffers based on the determined one or more phase shifts, and merging the aligned message parts into a single message buffer.

According to a third aspect disclosed herein, there is provided a controller for controlling a plurality of spatially separated transmitters, wherein each transmitter is configured to emit respective illumination for illuminating an environment, wherein each transmitter is configured to transmit a respective coded light signal, and wherein the controller is configured to: cause a first transmitter to transmit a first coded light signal comprising a first coded light message; cause a second transmitter to transmit a second coded light signal comprising a second coded light message, wherein the first coded light message and the second coded light message comprise a respective sequence of data symbols; and apply a phase shift in the sequence of data symbols of the first coded light message compared to the sequence of data symbols of the second coded light message, wherein the phase shift is applied such that, when the first and second coded light messages are transmitted by the first and second transmitters respectively, the sequence of data symbols of the first coded light message is different to the sequence of data symbols of the second coded light message, wherein the first coded light message is a cyclic permutation of the second coded light message.

In an example, the controller is configured to: cause the first transmitter and the second transmitter to begin transmitting the first coded light message and the second coded light message at the same time.

In an example, the controller is configured to: cause a notification comprising the applied phase shift to be transmitted to a receiver of the first and second coded light messages.

In an example, the controller is configured to: receive, from a receiver of the first and second coded light messages, a request to modify the applied phase shift; and modify the applied phase shift based on the received request.

In an example, the received request indicates which of the first and second transmitters are being viewed by the receiver, wherein the controller is configured to modify the applied phase shift based on whether one or both of the first and second transmitter are being viewed by the receiver according to the received indication.

In an example, the controller is configured to: receive an indication of a number of repeats of the coded light message required for the receiver to reconstruct a complete coded light message; and cause the first and second transmitter to transmit the first and second coded light message for at least the indicated number of repeats.

According to a fourth aspect disclosed herein, there is provided a luminaire comprising: the controller as disclosed herein, and one of said transmitters.

According to a fifth aspect disclosed herein, there is provided a method of controlling a plurality of spatially separated transmitters, wherein each transmitter is configured to emit respective illumination for illuminating an environment, wherein each transmitter is configured to transmit a respective coded light signal, wherein the method comprises:

causing a first transmitter to transmit a first coded light signal comprising a first coded light message;

causing a second transmitter to transmit a second coded light signal comprising a second coded light message, wherein the first coded light message and the second coded light message comprise a respective sequence of data symbols; and applying a phase shift in the sequence of data symbols of the first coded light message compared to the sequence of data symbols of the second coded light message, wherein the phase shift is applied such that, when the first and second coded light messages are transmitted by the first and second transmitters respectively, the order of data symbols of the first coded light message is different to the order of data symbols of the second coded light message, wherein the first coded light message is a cyclic permutation of the second coded light message.

According to a sixth aspect disclosed herein, there is provided a computer program comprising instructions such that when the computer program is executed on a computing device, the computing device is arranged to carry out any of the method steps disclosed herein.

According to a seventh aspect disclosed herein, there is provided a computer program product, the computer program product comprising code embodied on computer-readable storage and/or being downloadable therefrom, and being configured so as when run on a processing apparatus comprising one or more processing units to perform operations in accordance with any of the method steps disclosed herein.

According to an eighth aspect disclosed herein, there is provided a lighting system comprising: at least a first transmitter and a second transmitter, wherein each transmitter is configured to emit respective illumination for illuminating an environment, wherein each transmitter is configured to transmit a respective coded light signal; and a controller configured to control at least the first and second transmitters, wherein the controller is configured to: cause a first transmitter to transmit a first coded light signal comprising a first coded light message, cause a second transmitter to transmit a second coded light signal comprising a second coded light message, wherein the first coded light message and the second coded light message comprise a respective sequence of data symbols, and apply a phase shift in the sequence of data symbols of the first coded light message compared to the sequence of data symbols of the second coded light message, wherein the phase shift is applied such that, when the first and second coded light messages are transmitted by the first and second transmitters respectively, the order of data symbols of the first coded light message is different to the order of data symbols of the second coded light message, wherein the first coded light message is a cyclic permutation of the second coded light message.

### BRIEF DESCRIPTION OF THE DRAWINGS

To assist understanding of the present disclosure and to show how embodiments may be put into effect, reference is made by way of example to the accompanying drawings in which:

FIG. 1 shows schematically an example of an environment comprising a coded light communication system;

FIG. 2 shows schematically an example of a timing diagram of a rolling-shutter camera when detecting and reconstructing a coded light message;

FIG. 3 schematically illustrates a coded light message being reconstructed based on determined phase shifts applied to transmitted coded light messages;

FIG. 4 schematically illustrates a second coded light message being reconstructed based on previously determined phase shifts applied to transmitted coded light messages;

FIG. 5 schematically illustrates an example phase shift distribution based on the light sources present in the view of the receiver;

FIG. 6 schematically an example of a phase shift distribution dependent on the infrastructure of a coded light communication system;

FIG. 7 schematically illustrates examples of coded light messages wherein a phase shift has been applied at the sub-symbol layer; and

FIG. 8 is a schematic representation of a frame captured by a rolling shutter camera.

### DETAILED DESCRIPTION

With coded light, an encoding scheme is used to transfer data symbols (e.g. bits, nibbles, bytes, etc.) by modulating the light (for example, by using fast light pulses that vary in position, width or intensity). A receiving device (“the receiver”) can take the form of, for example, a photoresistor, a photodiode or a fast camera. For example, the receiver may be a rolling-shutter camera. In another example, the camera may be a global shutter camera. Rolling shutter cameras have the advantage that multiple light sources or effects can be taken into account and can be sampled at a higher speed (as consecutive lines are sampled at different time-stamps).

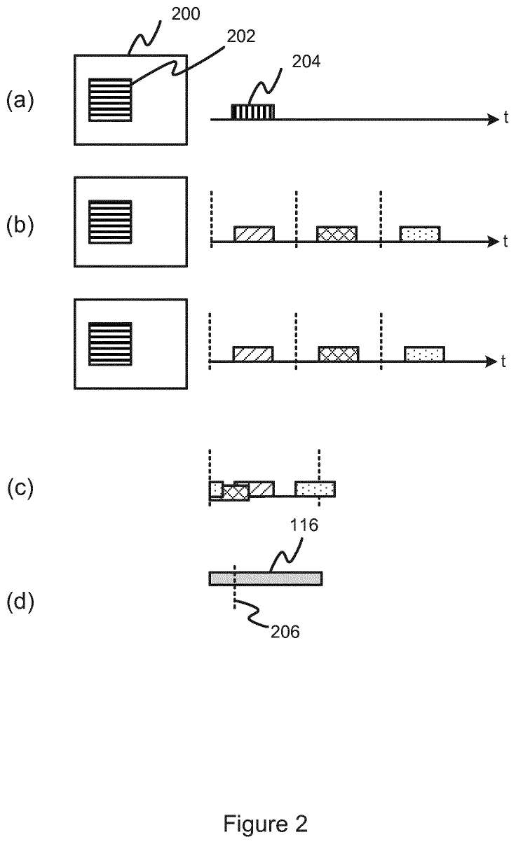

In FIG. 2(a), a camera captures a frame 200 in which a light source (or light effect) 202 is present. Due to the rolling shutter principle, the fast flashing light is detected as a series of stripes with different intensity. These stripes can be interpreted as a time dependent series of pulses 204. FIG. 2(b) illustrates that multiple frames are interpreted in this way, which leads to blocks of pulses on a timeline. In FIG. 2, the frame rate of the camera is indicated by the sequential, dotted vertical lines. As the light source (or effect) 202 occupies only a small part of the sensor/frame surface, a block contains only a small part of the signal.

When the light source emits the same sequence of data symbols in a loop (e.g. a lamp identifier), this means that there is an opportunity to reconstruct the complete coded light message. First, the camera and light source must have a difference in sampling speed and synchronization, such that a different part of the signal is detected in each frame. Secondly, the different received message parts must have some overlap which can be used to look for correlations at the start and end of the blocks. When some bit sequences are the same at the start and/or end of the message parts, this might indicate that the parts are adjacent. However, this is not always true; false adjacency can occur when bit patterns overlap but the parts are not adjacent.

The relative timing of the light source and sensor also help to position the detected parts into a message. This is illustrated in FIG. 2c where the timing for sampling a frame is a smaller than the time for sending a message. This means that when the message length is known, the detected parts can be positioned in a message buffer 116, the correlation in the overlapping parts can be verified and all the bits of the message can be detected. When the message buffer 116 is filled, the start of the message is not known, but the relative location of the bits (, i.e. the order in a circular buffer) is known. At that moment, the decoder can look for the start and stop sequence 206 in the message, and thus find the message or identifier that is emitted by the lamp in a loop. The start or stop sequence may e.g. be in the form of a pre/mid/post-amble or even an idle period; what is relevant is that it is a symbol, symbol sequence, or other channel state that deviates from the regular channel coding used for data.

One problem with previous coded light communication techniques is that when the light source (effect) 202 occupies only a small part of the sensor, the signal blocks are very small, and so the possible overlap is also very small and the probability of false adjacency increases.

A related problem is that the amount of light that occupies the sensor surface of a rolling shutter camera determines the number of decoded bits and thus the speed of detecting a complete message (e.g. a light source identifier) is reduced for small amounts of light.

When multiple lamps are present, more space is occupied so they can be used to speed up the collection of bits. However, a strategy to distribute sending of messages must be found to avoid too much overlap in the received message parts. For example, when two light sources are synchronized and are read out by the same rows of the sensor, the received bits are the same.

The inventors have recognised that the speed of reconstructing a coded light message at a receiver can be increased by transmitting the same coded light message by two or more light sources and distributing a phase shift across the transmitted coded light messages. As will be explained in detail below, this enables the receiver to reconstruct the message more quickly as different parts of the coded light message are sampled in each frame.

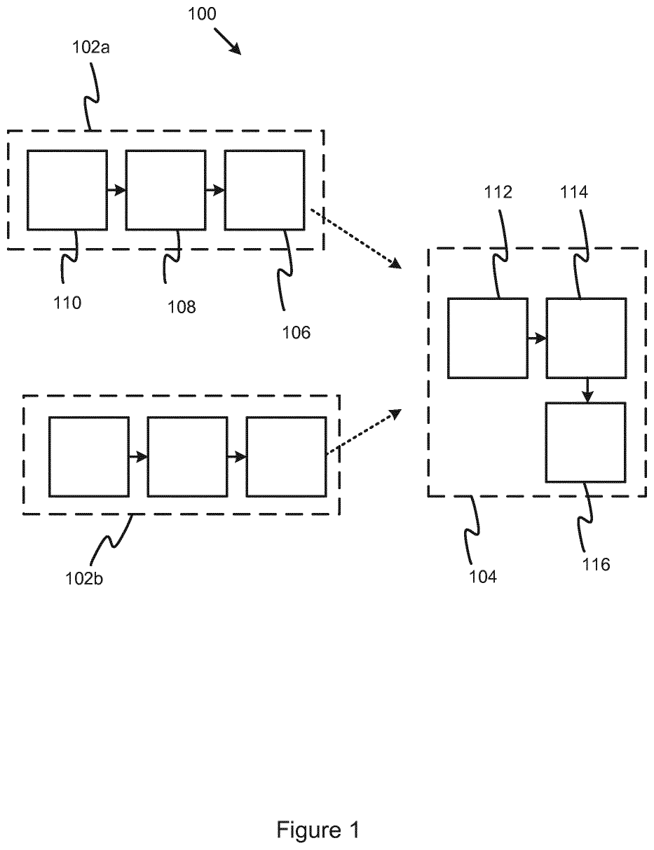

FIG. 1 gives a schematic overview of a system 100 for transmitting and receiving coded light. The system 100 comprises a plurality of transmitters 102 and a receiver 104. That is, the system 100 comprises at least a first transmitter 102a and a second transmitter 102b. For example a transmitter 102 may take the form of a luminaire or lighting device, e.g. mounted on the ceiling or wall of a room, or taking the form of a free-standing lamp, or an outdoor light pole. The receiver 104 may for example take the form of a mobile user terminal such as a smart phone, tablet, laptop computer, smartwatch, or a pair of smart-glasses.

The transmitter 102 comprises a light source 106 and a driver 108 connected to the light source 106. In the case where the transmitter 102 comprises a luminaire, the light source 106 takes the form of an illumination source (i.e. lamp) configured to emit illumination on a scale suitable for illuminating an environment such as a room or outdoor space, in order to allow people to see objects and/or obstacles within the environment and/or find their way about. The illumination source 106 may take any suitable form such as an LED-based lamp comprising a string or array of LEDs, or potentially another form such as a fluorescent lamp. The transmitter 102 also comprises a controller 110 coupled to an input of the driver 108, for controlling the light source 106 to be driven via the driver 108. Particularly, the controller 110 is configured to control the light source 106, via the diver 108, to modulate the illumination it emits in order to embed a cyclically repeated coded light message. Any suitable known modulation technique may be used to do this. In embodiments the controller 110 is implemented in the form of software stored on a memory of the transmitter 102 and arranged for execution on a processing apparatus of the transmitter 102 (the memory on which the software is stored comprising one or more memory units employing one or more storage media, e.g. EEPROM or a magnetic drive, and the processing apparatus on which the software is run comprising one or more processing units). Alternatively it is not excluded that some or all of the controller 110 could be implemented in dedicated hardware circuitry, or configurable or reconfigurable hardware circuitry such as a PGA or FPGA.

The receiver 104 comprises a camera 112 and a decoder 114 coupled to an input from the camera 112 in order to receive images captured by the camera 112. The receiver also comprise a plurality of message buffers 116. In embodiments, the decoder 114 and the plurality of message buffers 116 are implemented in the form of software stored on a memory of the receiver 104 and arranged for execution on a processing apparatus of the receiver 104 (the memory on which the software is stored comprising one or more memory units employing one or more storage media, e.g. EEPROM or a magnetic drive, and the processing apparatus on which the software is run comprising one or more processing units). Alternatively it is not excluded that some or all of the decoder 114 and the message buffers 116 could be implemented in dedicated hardware circuitry, or configurable or reconfigurable hardware circuitry such as a PGA or FPGA.

The controller 110 is configured to perform the transmit-side operations in accordance with embodiments disclosed herein, and the decoder 114 is configured to perform the receive-side operations in accordance with the disclosure herein. Note also that the controller 110 need not necessarily be implemented in the same physical unit as the light source 106 and its driver 108. In embodiments the controller 110 may be embedded in a luminaire along with the driver 108 and light source 106. Alternatively the controller 110 could be implemented externally to the transmitter 102, e.g. on a server or control unit connected to the transmitter 102 via any one or more suitable networks (e.g. via the internet, or via a local wireless network such as a Wi-Fi or ZigBee, 6LowPAN or Bluetooth network, or via a local wired network such as an Ethernet or DMX network). In the case of an external controller, some hardware and/or software may still be provided on board the transmitter 102 to help provide a regularly timed signal and thereby prevent jitter, quality of service issues, etc.

Similarly the decoder 114 need not necessarily be implemented in the same physical unit as the camera 112. In embodiments the decoder 114 may be incorporated into the same unit, e.g. incorporated together into a mobile user terminal such as a smartphone, tablet, smartwatch or pair of smart-glasses (for instance being implemented in the form of an application or “app” installed on the user terminal). Alternatively, the decoder 114 could be implemented on an external terminal. For instance the camera 112 may be implemented in a first user device such as a dedicated camera unit or mobile user terminal like a smartphone, tablet, smartwatch or pair of smart glasses; whilst the decoder 114 may be implemented on a second terminal such as a laptop, desktop computer or server connected to the camera 112 on the first terminal via any suitable connection or network, e.g. a one-to-one connection such as a serial cable or USB cable, or via any one or more suitable networks such as the Internet, or a local wireless network like a Wi-Fi or Bluetooth network, or a wired network like an Ethernet or DMX network.

The following describes a receiver 104 and method for improving the detection of coded light messages by reconstructing messages based on a determined phase shift between received messages.

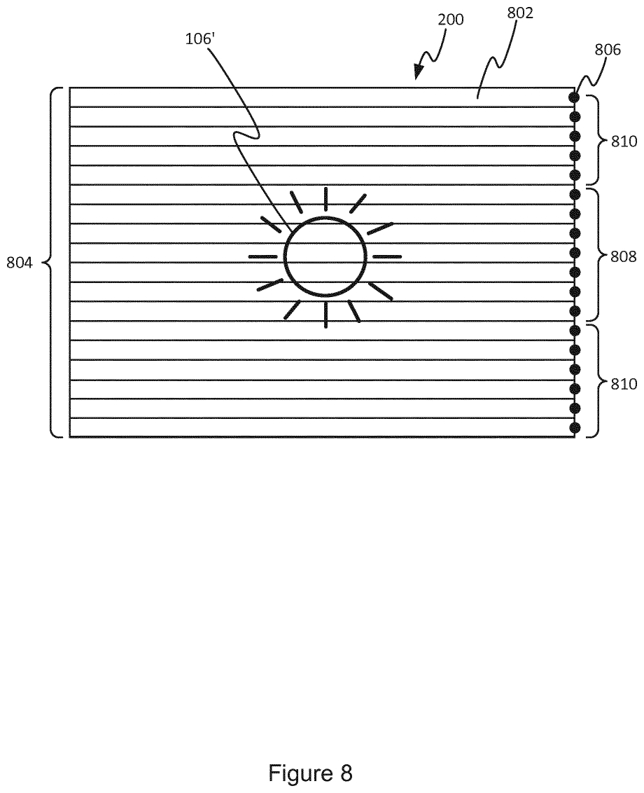

To aid the understanding of the present invention, an example representation of a frame captured by a rolling shutter camera is shown in FIG. 8. The camera 112 is arranged to capture a series of frames 200, which if the camera is pointed towards a light source 106 will contain an image 106′ of light from the light source 106. As discussed, the camera 112 in this example is a rolling shutter camera, which means it captures each frame 200 not all at once (as in a global shutter camera), but by line-by-line in a sequence of lines 802. That is, each frame 200 is divided into a plurality of lines 802 (the total number of lines being labelled 804 in FIG. 8), each spanning across the frame 200 and being one or more pixels thick (e.g. spanning the width of the frame 200 and being one or more pixels high in the case of horizontal lines). The capture process begins by exposing one line 802, then the next (typically an adjacent line), then the next, and so forth. For example the capturing process may roll top-to-bottom of the frame 200, starting by exposing the top line, then the next line from top, then the next line down, and so forth. Alternatively it could roll bottom-to-top, or even side to side. Of course if the camera 112 is included in a mobile or movable device such that it can be oriented in different directions, the orientation of the lines relative to an external frame of reference is variable. Hence as a matter or terminology, the direction perpendicular to the lines in the plane of the frame (i.e. the rolling direction, also referred to as the line readout direction) will be referred to as the vertical direction; whilst the direction parallel to the lines in the plane of the frame 200 will be referred to as the horizontal direction.

To capture a sample for the purpose of detecting coded light messages, some or all of the individual pixel samples of each given line 802 are combined into a respective combined sample 806 for that line (e.g. only the “active” pixels that usefully contribute to the coded light signal are combined, whilst the rest of the pixels from that line are discarded). For instance the combination may be performed by integrating or averaging the pixel values, or by any other combination technique. Alternatively a certain pixel could be taken as representative of each line. Either way, the samples from each line thus form a temporal signal sampling the coded light signal at different moments in time, thus enabling the coded light signal to be detected and decoded from the sampled signal. For completeness, in the example of FIG. 8, the light source 106 serving as a coded light transmitter only covers a fraction of the lines 802 of each frame 200. Actually, only the lines 808 in FIG. 8 contain pixels that record the intensity variations of the coded light source and thus lead to samples containing useful information. All the remaining “lines per frame” 810 and their derived samples do not contain coded light information related to the source 106 of interest.

Note that multiple light source/light effects may be present on the same line 802 in a frame 200. When this is the case, there is combined sample 806 for every series of pixels that belong to a single light source/effect, so there will be multiple combined samples 806 for a single line 802. That is, there are multiple samples per line 802, one for each light source/effect, with each sample being a combination of the active pixels which contribute to the coded light signal from a respective light source/effect. For example, if there are two spatially separated light sources captured on the same line 802 of a frame, there are two spatially separated sets of active pixels. Note that these combined samples 806 are not combined together, e.g. by summation. That is, an individual combined sample 806 of the multiple combined samples 806 on a single line is not then combined with another individual combined sample 806.

When a line 802 is exposed, if that line covers an area of the frame containing part of a coded light message, a sample of that coded light message part will be taken. As the next line is exposed at a slightly later time, a subsequent sample of that coded light message part will be taken, and so on. The samples together form a fragment of the message comprising one or more of the data symbols of the message, or part of a data symbol, i.e. more than one elementary channel symbols, as will be discussed in more detail below. When all of the lines have been exposed, the parts of the coded light messages in different parts of the frame 200 will have been sampled over different groups of lines which cover those different areas. The decoder then receives these sampled parts of the coded light messages.

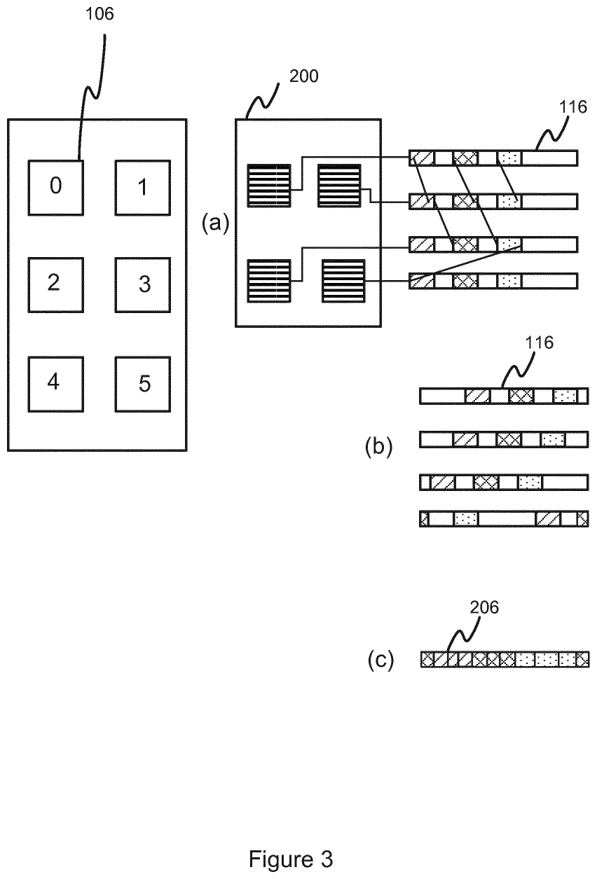

FIG. 3 shows an example of a receiver 104, e.g. a rolling shutter camera, being used to capture images of multiple light sources 106, e.g. ceiling lights. A decoder 114 of the receiver 104 has an input for receiving a plurality of image frames 200. Each image frame 200 contains parts of a coded light signal, each in a respective area of the frame, transmitted from each light source 106. When the coded light signals contain a coded light message transmitted from a respective light source 106, each frame then contains part of the coded light message in the respective area of the frame. The decoder 114 decodes each part of the coded light message and places the decoded parts into a respective message buffer 116. The respective message buffer 116 is associated with the area of the frame in which the respective message was captured. For example, in FIG. 3(a), a first light source 106 transmits a coded light signal which is captured in a first area of a first received frame. The decoder 114 decodes a first message part captured in the first received frame and places the first message part in a first message buffer 116. Similarly, a second message part decoded from a second area within the first frame is placed into a second message buffer 116. In this example, four of the six light sources 106 are captured in the received frames 200 and therefore four parts of four coded light messages are decoded and placed into four different message buffers 116.

In an example, a rolling shutter mechanism is used to capture a plurality of frames 200, the message bits in the first frame are then decoded from the light stripes in the frame and placed into a respective allocated message buffer 116.

After a first frame, the buffers contain first message parts of the received coded light messages, represented by diagonally striped blocks in FIG. 3. The relationship between the positions of the first message parts in the different message buffers 116 is not known at this point. The decoder 114 can search for correlations between the first message parts, or rather the decoder 114 can search for correlations between the data symbols within each first message parts. For example, correlations between at least two message buffers 116 are searched for. This is shown schematically in FIG. 3(b), where correlations are searched for between the first and second message buffers 116, between the second and third message buffers, and so on. In another example, correlations between the message parts in all message buffers 116 are searched for.

At this point, the decoder 114 may determine, based on the determined correlations in the data symbols, one or more phase shifts between the data symbols between pairs of message parts in the buffers. For example, a phase shift may be determined between the data symbols in the first and second message buffers. Another phase shift may be determined between the data symbols in the second and third message parts, and so on. In another example, a phase shift between the data symbols in the first and third message buffers may be determined. In examples, a phase shift may be determined, depending on the determined correlations, between the data symbols in any possible combination of message buffers 116.

Another method for determining the phase shifts without determining correlations in the data symbols is by searching for distinctive patterns within the message. For example, if a message is emitted with a certain pattern, e.g. 01001100011100001111, the burst 0110 can be located directly. The same applies for the burst1110. By receiving some bursts, the phase shifts can be determined.

Distinctive patterns may be patterns that “violate” channel coding for data symbols, as a result such patterns can be easily recognizable. One way would e.g. be the insertion of pre/mid/post-ambles or even an idle period in between messages. The decoded message parts can then be placed and aligned in the message buffer based on these specific symbols/patterns.

Depending on the size of the coded light message and/or the applied phase shifts to the coded light message, the decoder 114 may reconstruct a coded light message by aligning the decoded message parts (and therefore the data symbols within the decoded message parts) based on the determined phase shifts. The aligned message parts are merged into a single message buffer 206, as shown in FIG. 3(c). For example, if the first frame captures four different parts of a complete coded light message with a phase shift of 25% in the data symbols between each consecutive pair of transmitted messages, a first received frame will capture the complete coded light message.

In some instances, multiple frames 200 are required to enable the reconstruction of a complete coded light message. After each frame is received, the message parts in each area of each fame are decoded and placed into a respective message buffer 116. For example, the cross-hatched blocks in FIG. 3(a) represent message parts received in and decoded from a second received frame. Each decoded message part is placed into the same message buffer 116 as a previously decoded message part corresponding to the same area within a previous frame. Similarly, in FIG. 3a, dotted blocks represent message parts received in and decoded from a third received frame.

The decoder 114 may search for correlations between the data symbols placed in each message buffer 116 on a per frame basis. That is, as each frame is received and message parts are decoded and placed in the message buffers 116, the decoder 114 may search for correlations between the latest decoded message parts placed in the message buffers 116. That is, when a first frame is processed, correlations are searched for between symbols that were decoded from the first frame. Then when a second frame is processed, correlations are searched for between symbols that were decoded from the second fame. This may be repeated for each subsequently received frame. An example of this is shown in FIG. 3(b). Additionally or alternatively, the decoder 114 may search for correlations between two or more of the decoded message parts placed in each message buffer 116, e.g. for correlations between data symbols decoded from the first, second and third received frame. As discussed above, correlations may be determined between one or more pairs of message buffers 116.

Based on the determined correlations in the data symbols, the decoder 114 can then determine one or more phase shifts between the decoded message parts from the multiple received frames 200. The decoder 114 can then use the phase shift(s) to align the decoded message parts and merge them into a single message buffer 206 to reconstruct a complete coded light message, as shown in FIG. 3(c).

As an optional feature, the decoder 114 may search for correlations between data symbols one frame's worth of decoded message parts at a time. The decoder 114 may use these correlations to estimate one or more phase shifts between the decoded message parts. A check can then be performed to verify the estimated phase shift(s). For example, the decoder 114 may determine whether the data symbols in corresponding positions in the message buffers 116 are the same or not. If the estimated phase shift(s) are verified, the coded light message is reconstructed. If the estimated phase shift(s) are not verified, the decoder 114 searches for correlations between symbols in the second and subsequently received frames 200 until the estimate phase shift(s) can be verified.

Taking the example of FIG. 3, after decoding the first frame, the four message buffers 116 contain a first frame's worth of decoded message parts. A first verification is performed on any possible correlation (e.g. overlap) of the first decoded message parts. In this example, there is some correlation between the first decoded message parts. At this point, the phase shift(s) may be known, but the decoder 114 may not be certain. As a second and third frame are received, the message buffers 116 contain more data symbols which can be searched for correlations. As more frames 200 are received, the likelihood of determining the correct phase shift(s) increases and therefore the estimated phase shift(s) become more accurate.

Searching means that overlap between message parts in the different message buffers 116 is searched for. At that point, the phase shift(s) between the buffers may be assumed. Verifying means that, given the assumed shift, checking whether all known bits in corresponding positions in the buffers are equal. The phase shift(s) can be verified if the merge of the message buffers 116 results in a complete message, without differences at corresponding data symbol positions. Here, corresponding positions may mean identical positions within the message buffers 116. Alternatively, corresponding positions may also refer to data symbols that are positioned within a threshold of one another in the message buffers 116.

Furthermore, note that the message buffers 116 themselves do not need to be fully filled in order to reconstruct a complete message, as shown in FIG. 3(b).

In some examples, the decoder 114 searches for and identifies a start/stop or stop/start sequence within the decoded message parts in the message buffers 116. This enables the decoder 114 to align the complete coded light message in a message buffer, beginning with the start sequence (i.e. the start of the coded light message).

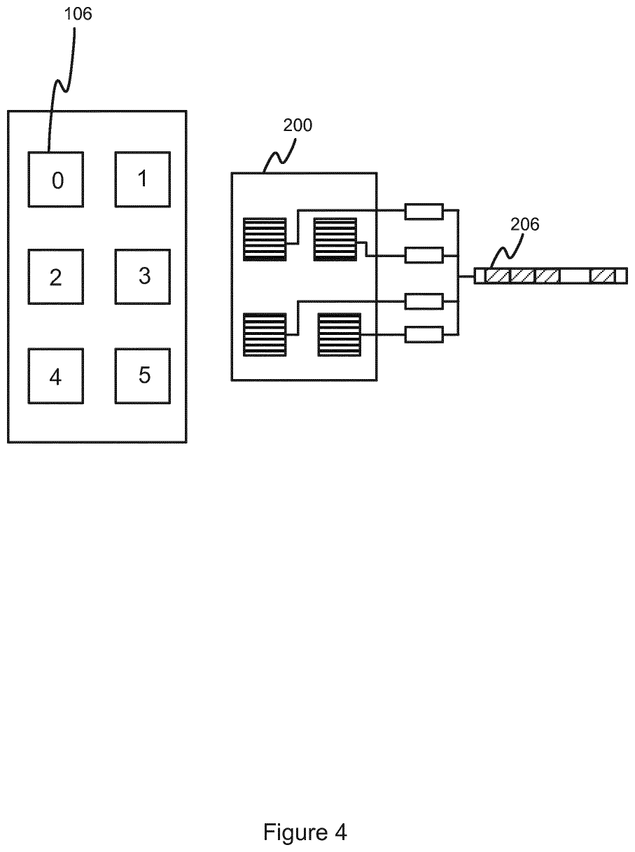

After reconstructing a first complete coded light message, the decoder 114 is aware of the phase shift(s) between the light sources 106 captured in the images taken by the receiver 104. That is, if the decoder 114 knows the phase shift between two message buffers 116, the decoder 114 also knows the phase shift between the two light sources 106 captured in the two areas within the frame to which those two message buffers 116 were allocated. Then, when the transmitters 102 are controlled to transmit a second coded light message, the decoder 114 can use the determined phase shift(s) to place the decoded message parts directly into a single message buffer 206 in the correct position. This is shown schematically in FIG. 4. In this example, instead of placing the four decoded message parts into four respective message buffers 116, the four decoded message parts are placed into a single message buffer 206. Subsequent frames 200 may then be processed until the message buffer is fully filled (that is, if the message buffer is not filled after the first frame has been processed.)

An advantage of this is that by knowing the phase shift(s) between the light sources 106, decoded message parts from different sampled areas can be placed directly in the message buffer and therefore increase the speed of processing coded light messages. In examples, when the decoder 114 receives a different coded light message, or part of a different coded light message, this can be quickly detected as the data symbols in the newly received message can be compared with the data symbols in the aligned message buffer. Any difference in the compared messages will indicate that a different coded light message is being received. This enables the message buffer to be cleared, into which the newly received message can be placed.

As an optional feature, the receiver 104 may be configured to receive the phase shifts applied by the light sources 106. For example, one or more of the light sources 106 responsible for the coded light signals in the received frames 200 may transmit a notification containing the phase shifts. As another example, a server configured to control the light sources 106 within the lighting system 100 may transmit the notification. In these examples, the receiver 104 comprises a wired or wireless interface configured to receive information over a wired or wireless communication channel respectively. For example, the notification may be received over a radio frequency (RF) channel. The decoder 114 may use the received phase shift(s) to correctly align the decoded message parts. The decoder 114 may place decoded message parts directly into a single message buffer 206 based on the received phase shift(s).

As another optional feature, the decoder 114 may generate a request to modify one or more of the phase shifts applied by the light sources 106. The receiver 104 may then transmit the request to one or more of the light sources 106 and/or to the server. For example, the decoder 114 may determine that a phase shift between two or more light sources 106 produces too much overlap between the data symbols in the received message parts. The decoder 114 may determine an optimal phase shift(s) to be applied across the two or more light sources 106 and cause the receiver 104 to transmit a request to the light sources 106 to apply the optimal phase shift(s).

Furthermore, the decoder 114 may also generate a request to modify one or more of the phase shifts applied by the light sources 106 based on which light sources 106 are present in the received frames 200. The decoder 114 may determine, based on the area(s) in the received frames 200 containing coded light signals, which of the light sources 106 within the lighting system 100 are being sampled. The decoder 114 may cause this information to be transmitted to the one or more light sources 106. The light sources 106 may adapt the phase shift(s) based on this information.

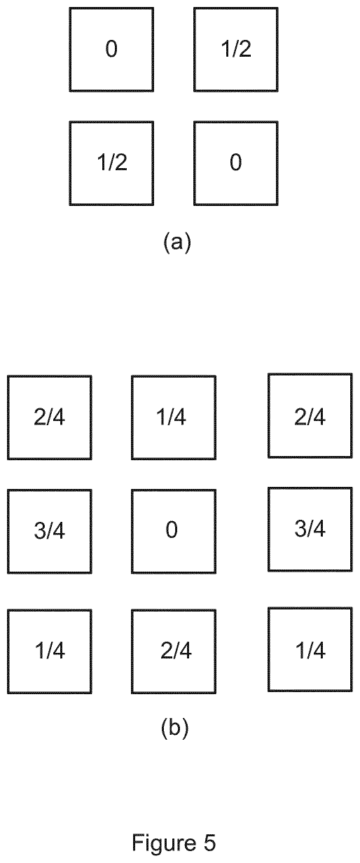

Alternatively, the decoder 114 may determine the number of light sources 106 visible based on which light sources 106 are present in the frames 200. The decoder 114 may then determine the optimal phase shifts to be applied across those light sources 106 that are determined to be present. For example, the decoder 114 may determine that two light sources 106 are present in the received frames 200. The receiver 104 may then transmit a request for the light sources 106 to implement, for example, a 25% or 50% phase shift in the message symbols transmitted between the coded light messages transmitted by the two light source 106s. This is shown schematically in FIG. 5a for a % 0% phase shift. In another example, when four light sources 106 are determined to be present, the receiver 104 may transmit a request for the light sources 106 to implement, for example, a 25% phase shift between each light source 106, e.g. 0%, 25%, 50%, 75%. This is shown schematically in FIG. 5b. When a fast sampling global shutter camera 112 is used, there is no rolling shutter phase shift and the distribution of the coded light messages indicated in the described examples avoids any overlap in the coded light messages.

In some examples, the receiver 104 operates first detection mode to detect which light sources 106 are present in the received frames/view, and then in a second detection mode to detect the phase shifted coded light messages. Detecting which light sources 106 are present in the received frames 200 may be performed by detecting a transmitted light source identifier, techniques for which are known in the art.

As an option, the decoder 114 may also determine the number of repeats of a message required for the decoder 114 to reconstruct a complete message. The receiver 104 may transmit this information to the one or more light sources 106 (e.g. those determined to be present in the received frames 200). The receiver 104 may indicate a greater number of messages to be repeated than the minimum number so that the positioned decoded message parts may be verified by checking for errors.

Note that when the decoder 114 operates on the rolling shutter principle, there is also a phase shift in receiving the samples in the different rows/columns of the sensor. This phase shift can be determined from the timing of the rolling shutter mechanism. The decoder 114 can therefore compensate for this additional phase shift, e.g. by subtracting the additional phase shift.

The following describes a controller 110 and method for enabling the improved detection of coded light messages at a receiver 104. As described above, a controller 110 is configured to control two or more transmitters 102, with each transmitter having one or more light sources 106 for transmitting coded light signals. The controller 110 is configured to embed a coded light message into the transmitted coded light signals. The controller 110 controls the transmission of the coded light messages, such that the controller 110 may cause a first and second transmitter to transmit a first and second coded light signal containing respective coded light messages. Each coded light message is made up of a sequence of data symbols. The controller 110 is also configured to apply a phase shift to the sequence of data symbols of one of the transmitted coded light messages relative to at least one other transmitted coded light message. The phase shift is applied so that when the two or more coded light messages are transmitted, the coded light messages contain a different sequence of messages compared to one another. Further, each coded light message transmitted by each transmitter is a cyclic permutation of one another. That is, each message is made up of a shifted version of the same data content.

For example, each coded light message may be made up of a sequence of ones and zeros. For example, a first coded light message may be [0 1 1 0 1 0 1 1 0 0]. The second coded light message may have a 50% phase shift applied in a circular manner. In this scenario, the second coded light message would be [0 1 1 0 0 0 1 1 0 1]. In a different scenario, a 20% phase shift may be applied, resulting in the second coded light message being [0 0 0 1 1 0 1 0 1 1]. Put another way, if the sequence of data symbols of the first coded light message were shifted one symbol at a time, together in order, in a cyclic manner, eventually the first coded light message would be equivalent to the second coded light message.

In some examples, the phase shift is applied to the first coded light message such that the data symbols of the first coded light message are shifted by an integer number of data symbols compared to the second coded light message.

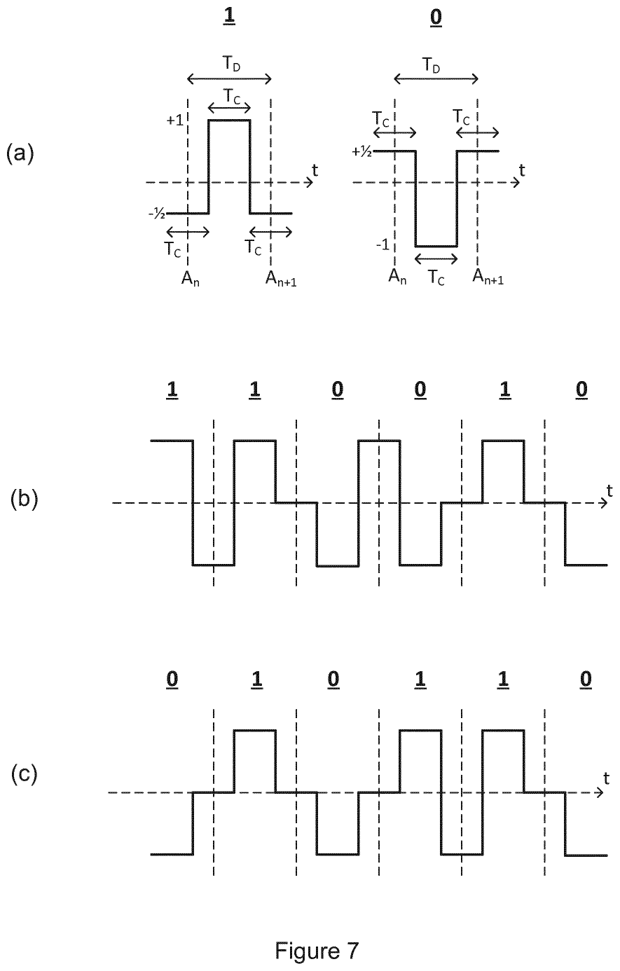

The phase shift may also be applied at the sub-symbol level, i.e. to the respective unit pulse representing each data symbol (e.g. each data bit). FIG. 7 shows two possible unit pulses in the form of positive and negative “hat” functions. The pulse mapped to a data symbol of value 1 is shown on the left hand side of FIG. 7, and the pulse mapped to a data symbol of value 0 is shown on the right hand side of FIG. 7. For example, in the ternary Manchester code, each unit hat function comprises a sequence of three elementary channel periods of length T_{C} in time, each half the length of the data symbol period T_{D} (T_{D}=2T_{C}). The three elementary periods for a respective data symbol are contiguous, with the middle of the three being located at the centre of the respective data symbol period, so that the adjacent first and third elementary channel periods straddle the beginning and end boundaries of the data symbol period respectively by half an elementary channel period T_{C} either side. In some examples, when the phase shift is applied at the sub-symbol level, the phase shift applied to the first coded light message may be a shift of an integer number of elementary channel symbols relative to the second coded light message.

To create a coded light message to be transmitted, the hat functions of adjacent data symbols are added to one another, offset by the times of their respective symbol periods. Because the hat functions overlap across the boundaries between data symbol periods, the functions add in the overlapping regions between adjacent data symbols.

An example of a resulting sequence of data symbols in the time domain is shown in FIG. 7b. FIG. 7b represents an example of a first coded light message transmitted by a first transmitter. FIG. 7c represents an example of a second coded light message transmitted by a second transmitter with a 50% phase shift applied by the controller 110 to the second coded light message compared to the first coded light message. As shown in FIG. 7, the two coded light messages are transmitted with different orders of sequence symbols, with one coded light message being a cyclic permutation of the other.

Whilst example phase shifts of 25% and 50% have been provided, in other examples, the applied one or more phase shifts may be greater than or less than these values.

An advantage of this is that different versions of the same coded message can be transmitted which enables a receiver 104 to sample different parts of the same coded light message in the same frame. A further advantage is that even when transmitters 102 that are sampled on the same row of a receiver 104 (e.g. the same row of a rolling shutter camera 112) different parts of the same coded light message are still received, instead of the same part as is typically the case.

The one or more phase shifts applied by the controller 110 may be predetermined by the controller 110 or randomly distributed across the transmitters 102. The phase shifts applied across the transmitters 102 when transmitting first coded light signals containing versions of a coded light message will be maintained for the transmission of the next set of coded light signals containing versions of a different coded light message. This enables the receiver 104 to reconstruct the different coded light message based on known phase shifts.

In some examples, the controller 110 controls each transmitter to being transmitting their respective coded light messages at the same time. That is, the transmission of coded light messages is synchronized across the transmitters 102 by synchronizing the transmitter clocks. In alternative examples, the transmitters 102 may operate with a small clock drift. The controller 110 may reset the clock times of the transmitters 102 if the clock drift reaches a defined threshold.

The potential speed-up realized by using this technique is amongst others dependent on the number of luminaires that are typically imaged in a regular use case, as well as their respective off-sets at the moment of imaging. As a result the above reset of the transmissions on request may provide for an alignment and thereafter a higher speed-up.

One way of synchronizing the transmission of messages is by using a phase locked loop in combination with a specific light pulse (e.g. a light pulse of a length which is not used in normal (pulse width modulation) communication or illumination). The transmitters can synchronize on the pulse and then emit the pulse together with the other lamps to effectively put a pace in the environment. Furthermore, the receiver can also synchronize on that pulse and adapt its clock based on this.

As an option, the controller 110 is configured to cause the applied one or more phase shifts to the receiver 104 to be transmitted to a receiver 104. For example, the controller 110 may generate an indication containing the phase shift(s). One or more of the transmitters 102 may be controlled to transmit the indication to the receiver 104. The transmission may be, for example, over a wired or wireless connection. An example of a wireless connection for the transmission may be a RF channel.

The controller 110 may also, as an additional or alternative option, be configured to receive a request to modify one or more applied phase shifts, before, during or after transmission of the first instances of the coded light message. The request may be received at the transmitter from a receiver 104 and then processed by the controller 110. In some example, the request is first transmitted from the receiver 104 to an intermediate node, such as a central lighting bridge or a server, and then forwarded to controller 110. Based on the received request, the controller 110 may choose to modify the applied phase shift(s). For example, the controller 110 may increase or decrease the relative phase shift in the messages transmitted by one or more pairs of transmitters 102.

In some examples, the received request indicates which transmitters 102 are being viewed by the receiver 104, e.g. sampled by a camera 112 of the receiver 104. The received request may indicate which of the transmitters 102 are prominently viewed by the receiver 104, e.g. viewed in their entirety. The controller 110 may process the request and modify the applied phase shift based on whether one or more of the transmitters 102 (e.g. both transmitters 102a and 102b) are viewed by the receiver 104. For example, three transmitters 102 may be transmitting coded light messages with a 33% phase shift relative to one another. The controller 110 may process a request which indicates that one of the transmitters 102 is not being (prominently) viewed by the receiver 104. The controller 110 may therefore modify the phase shift applied across the two transmitters 102 that are being viewed. For example, the two viewed transmitters 102 may be controller 110 to transmit coded light messages with a 50% phase shift.

As another option, the controller 110 may be configured to receive and process an indication detailing the number of repeats of the coded light message required for the receiver 104 to reconstruct a complete coded light message. The controller 110 may use this indication to control the number of time one or more of the transmitters 102 transmits their respective message.

The controller 110 may also introduce redundancy into the coded light messages based on a parity scheme, such that the complete coded light message can be composed of sub messages distributed over a number of transmitters 102 that is smaller than the number that is currently in the receiver's field of view. To make sure the reconstructed message is the same as the original message, it is possible to include parity volumes with a ratio. Parity volumes enable the receiver 104 to fix reconstructed messages if the size of a broken section (e.g. containing errors) is smaller than the sum of parity volumes. In this approach, a ratio of the transmitted message is reserved for parity. For example, in a room with six transmitter, to ensure that a complete message can be reconstructed when the receiver 104 views only four of the six transmitters 102, one third of each message may be set aside as parity sections.

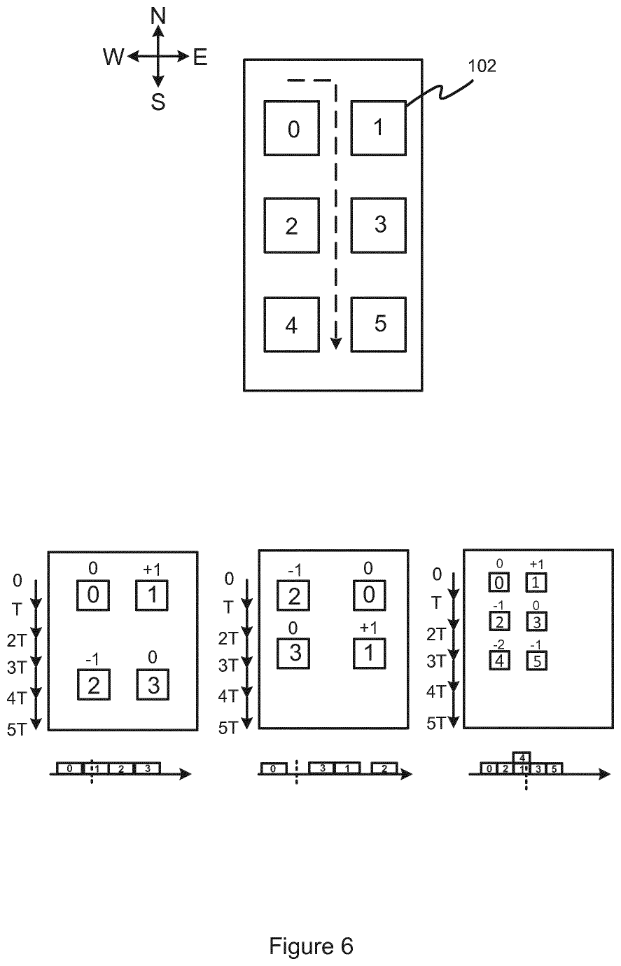

FIG. 6 illustrates an example of how phase shifts can be distributed over transmitters 102 and how the received message parts can be placed in a message buffer 116. The ceiling view shows six transmitters 102 and their orientation. A receiver 104 can have a view on (a part of) this ceiling. All the transmitters 102 will emit the same message string, and by observing a single lamp with a rolling shutter camera 112, it is possible to detect and align all the data symbols of the message. If lamp 0 and 1 are in phase, the receiver 104 used in the view 1 will receive exactly the same data in the rows. So by applying a phase shift, which can be derived by the receiver 104, the data symbols detected in area 0 and 1 can be placed at a good relative location in the message buffer 116, with minimal overlap.

Suppose T is the time for reading the bits in the sensed area for a transmitter (in view 1), and define the moment that the sensor reads out area 0 as time=0. Suppose a complete message is emitted in time=8 T. If a phase shift of+1 T is applied for transmitter 1, this means that the sensor in view 1 starts reading the message parts 0−1 T from area 0 and 1−2 T from area 1. As the rolling shutter mechanism proceeds, it starts reading the areas 2 and 3 at time 3 T. By applying a phase shift of −1 T for area 2 and no phase shift for area 3, it can be concluded that message parts (2−3)T are read from area 2 and (3−4)T from area 3. In this situation, the sensor reads four blocks of the message in one frame, or 50% of the message with length 8T. By adapting the timing of the camera sensor in reading the next frame, it is also possible to read the other 4 messages parts in one frame (start reading area0 on time n*8*T+4 T). The message buffer 116 may not be synchronized with the start of the message, so the stop/start sequence may have to be searched in the message buffer 116. In this example, the phase shift is made dependent on the orientation of the transmitters 102: a phase shift on +1 T is applied in the East Direction and −1 T in the South direction.

In view 2, the receiver 104 is rotated 90 degrees counter clockwise. The same phase shifts are applied. So the sensor starts reading areas 2 and 0 (at reference time 0) and reads areas 3 and 1 at time 2 T. The phase shifts can be derived by the receiver 104 by taking the orientation of the sensor into account. By taking area 0 at time 0 as the reference, one can deduce that area 2 delivers the end of the (unsynchronized) message at time 0 (7−8)T. Areas 3 and 1 deliver message parts (2−3)T and (3−4)T.

In view 3, the receiver 104 has a broader view on the ceiling, so there are more lamps in the view but the sensor area occupied by the lamps is only the half. By defining the readout of area 0 as time=0, one can deduce that area 2 is read at time 1.5 T and area 4 at time 3 T. The message parts contain half the amount of data symbols. So area 0 delivers (0−0.5)T and area 1 delivers (1−1.5)T. As the sensor reading progresses, one can see that the areas deliver the following data symbols: area 2: (0.5−1)T, area 3: (1.5−2)T, area 4: (1−1.5 T) and area 5: (2−2.5)T. The transmitter/light source effect size influences the detection area on the sensor, and the distance between the lamps determines the read-out timing on the sensor. So, the geometry of the lighting infrastructure can be taken into account when calculating the phase shifts.

It will be appreciated that the embodiments above have been described only by way of example. For example, as discussed above, whilst the examples above have been discussed in relation to a rolling shutter camera, the frames received at the decoder may also be captured by a different type of camera such as, for example, a global shutter camera. When using a global shutter camera, the camera captures the entire frame at the same time and therefore captures different parts of the transmitted coded light messages (due to the applied phase shifts) in each area of the frame. For example, if the phase shifts of FIG. 5b are applied and the camera captures a frame in which the top left corner of the transmitters are captured, each frame will contain four different parts of the message. Each part of the message captured in the four areas within the frame will be shifted by 25% relative to the message part in the area above or below and also by 25% relative to the message part in the area to the right or left. In the subsequently captured frame, four different parts of the message will be captured, with each part being shifted by 25% as described above. As a specific example, if the frame rate is twice the bit/signal rate (e.g. Nyquist), the consecutive bits can be found, and the message buffer grows from several places (related to the amount of light sources in the frame) to a situation where the message parts of data symbols start to overlap, and the buffer gets completely filled. At that moment, the phase shifts are known. For a second message, the data symbols can be placed directly in the buffer.

The present invention may be particularly beneficial when the message transmitted by the luminaires is a continuously transmitted message of a known length such as a (long) identifier. By having multiple transmitters/luminaires transmit the message out of phase, and possible in an orchestrated manner such that the phase offset(s) are staggered, and preferably distributed evenly over the message length, a higher identifier detection speed may be achieved, resulting in a e.g. a faster indoor localization.

A similar approach may however also be used in a data-transmission scenario, wherein packets of a known length need to be transferred. In such a scenario individual packets may be repeated by the luminaires until the packet has been successfully received by the receiver. In this scenario the receiver may provide an acknowledgement on successful receipt of a packet (e.g. after verification of using a checksum), after which the transmitters may move on to transmit the next packet.

Reference has been made herein to data storage for storing data. This may be provided by a single device or by plural devices. Suitable devices include for example a hard disk and non-volatile semiconductor memory.

Although at least some aspects of the embodiments described herein with reference to the drawings comprise computer processes performed in processing systems or processors, the invention also extends to computer programs, particularly computer programs on or in a carrier, adapted for putting the invention into practice. The program may be in the form of non-transitory source code, object code, a code intermediate source and object code such as in partially compiled form, or in any other non-transitory form suitable for use in the implementation of processes according to the invention. The carrier may be any entity or device capable of carrying the program. For example, the carrier may comprise a storage medium, such as a solid-state drive (SSD) or other semiconductor-based RAM; a ROM, for example a CD ROM or a semiconductor ROM; a magnetic recording medium, for example a floppy disk or hard disk; optical memory devices in general; etc.

In the claims, the word “comprising” does not exclude other elements or steps, and the indefinite article “a” or “an” does not exclude a plurality. A single processor or other unit may fulfil the functions of several items recited in the claims. A computer program may be stored/distributed on a suitable medium, such as an optical storage medium or a solid-state medium supplied together with or as part of other hardware, but may also be distributed in other forms, such as via the Internet or other wired or wireless telecommunication systems.

Any reference signs in the claims should not be construed as limiting the scope.

1. A receiving apparatus for receiving a coded light message from a plurality of spatially separated transmitters that each transmit the coded light message by modulating an intensity of its transmitted visible light, wherein the different transmitters are configured to transmit phase shifted versions of the coded light message relative to one another, the receiving apparatus comprising:
an interface configured to receive, from a camera, one or more frames, each frame capturing a plurality of respective parts of the coded light message in a plurality of spatially separated respective areas in each frame over time, wherein each respective part originates from a different respective transmitter and is captured in a different spatially separated respective area, and wherein the coded light message comprises a sequence of data symbols;
a plurality of message buffers; and
a decoder configured to:
decode the respective parts of the coded light message captured in each frame;
place each of the decoded parts into a respective message buffer, wherein each respective message buffer is associated with one of the plurality of respective areas within each frame;
determine, based on the data symbols placed in the message buffers, one or more phase shifts in the data symbols between each of one or more pairs of two or more decoded parts; and
reconstruct the coded light message, wherein said reconstructing comprises aligning the decoded parts in the message buffers based on the determined one or more phase shifts, and merging the aligned decoded parts into a single message buffer.

2. A receiving apparatus according to claim 1, wherein the decoder is configured to:
perform said decoding, placing and determining for a first set of the received frames;
wherein said determining of the one or more phase shifts comprises estimating, based on any correlations between the data symbols of two or more of the decoded parts decoded from the first set of the received frames, the one of more phase shifts;
verify the estimated one or more phase shifts by determining whether the data symbols in corresponding positions in the respective message buffers are the same; and
if the data symbols in corresponding positions in the respective message buffers are determined to be the same, reconstruct the coded light message based on the verified one or more phase shifts; or
if the data symbols in corresponding positions in the respective message buffers are determined not to be the same, repeat said performing, estimating and verifying for one or more subsequent sets of the received frames until the estimated one or more phase shifts are verified.

3. A receiving apparatus according to claim 1, wherein the decoder is configured to:
receive a further one or more frames comprising coded light signals in the plurality of respective areas within each frame, each frame capturing a part of a second coded light message within the coded light signals in the plurality of respective areas;
decode the respective parts of the second coded light message captured in each frame; and
reconstruct the second coded light message by placing the decoded parts in the single message buffer, wherein the decoded parts are aligned in the single message buffer based on the previously determined one or more phase shifts.

4. (canceled)

5. A receiving apparatus according to claim 1, wherein the decoder is configured to:
generate a request to modify at least one of the one or more phase shifts; and
wherein the receiving apparatus is configured to transmit the generated request to one or more transmitters from the plurality of spatially separated transmitters responsible for transmitting the coded light signals in the received plurality of frames.

6. A receiving apparatus according to claim 5, wherein the decoder is configured to:
determine which of the one or more transmitters from the plurality of spatially separated transmitters responsible for transmitting the coded light signals are present in the received frames;
wherein the request to modify at least one of the one or more phase shifts is based on which of the one or more transmitters are present in the received frames.

7. A method of reconstructing a coded light message from a plurality of spatially separated transmitters that each transmit the coded light message by modulating an intensity of its transmitted visible light, wherein the different transmitters are configured to transmit phase shifted versions of the coded light message relative to one another, the method comprising:
receiving one or more frames, each frame capturing respective parts of the coded light message in a plurality of spatially separated respective areas in each frame over time, wherein each respective part originates from a different respective transmitter and is captured in a different spatially separated respective area, wherein the coded light message comprises a sequence of data symbols;
decoding the respective parts of the coded light message captured in each frame;
placing each of the decoded parts into a respective message buffer, wherein each respective message buffer is associated with one of the plurality of respective areas within each frame;
determining, based on the data symbols placed in the message buffers, one or more phase shifts in the data symbols between each of one or more pairs of two or more decoded parts from the corresponding different transmitters; and
reconstructing the coded light message, wherein said reconstructing comprises aligning the decoded parts in the message buffers based on the determined one or more phase shifts, and merging the aligned message parts into a single message buffer.

8. A controller for controlling a plurality of spatially separated transmitters, wherein each transmitter is configured to emit respective illumination for illuminating an environment, wherein each transmitter is configured to transmit a respective coded light signal by modulating an intensity of the respective illumination light emitted, and wherein the controller is configured to:
cause a first transmitter to transmit a first coded light signal comprising a first coded light message;
cause a second transmitter to transmit a second coded light signal comprising a second coded light message, wherein the first coded light message and the second coded light message comprise a respective sequence of data symbols; and
apply a phase shift in the sequence of data symbols of the first coded light message compared to the sequence of data symbols of the second coded light message,
wherein the phase shift is applied such that, when the first and second coded light messages are transmitted by the first and second transmitters respectively, the sequence of data symbols of the first coded light message is different to the sequence of data symbols of the second coded light message,
wherein the first coded light message is a cyclic permutation of the second coded light message.

9. A controller according to claim 8, wherein the controller is configured to:
cause the first transmitter and the second transmitter to begin transmitting the first coded light message and the second coded light message at the same time.

10. (canceled)

11. A controller according to claim 8, wherein the controller is configured to:
receive, from a receiver of the first and second coded light messages, a request to modify the applied phase shift; and
modify the applied phase shift based on the received request.

12. A controller according to claim 11, wherein the received request indicates which of the first and second transmitters are being viewed by the receiver,
wherein the controller is configured to modify the applied phase shift based on whether one or both of the first and second transmitter are being viewed by the receiver according to the received indication.

13. A luminaire comprising:
the controller according to claim 8; and
one of said transmitters.

14. A method of controlling a plurality of spatially separated transmitters, wherein each transmitter is configured to emit respective illumination for illuminating an environment, wherein each transmitter is configured to transmit a respective coded light signal by modulating an intensity of the respective illumination light emitted, wherein the method comprises:
causing a first transmitter to transmit a first coded light signal comprising a first coded light message;
causing a second transmitters to transmit a second coded light signal comprising a second coded light message, wherein the first coded light message and the second coded light message comprise a respective sequence of data symbols; and
applying a phase shift in the sequence of data symbols of the first coded light message compared to the sequence of data symbols of the second coded light message,
wherein the phase shift is applied such that, when the first and second coded light messages are transmitted by the first and second transmitters respectively, the order of data symbols of the first coded light message is different to the order of data symbols of the second coded light message,
wherein the first coded light message is a cyclic permutation of the second coded light message.

15. A computer program comprising instructions such that when the computer program is executed on a computing device, the computing device is arranged to carry out a method according to claim 7.
